(19) United States
(12) Patent Application Publication
(10) Pub. No.: US 2025/0050588 A1
(43) Pub. Date: Feb. 13, 2025

(54) MODIFICATION OF PART REPRESENTATIONS FOR ADDITIVE MANUFACTURING

(71) Applicant: MANTLE INC., San Francisco, CA (US)

(72) Inventors: Stephen T. Connor, San Francisco, CA (US); Michael A. Kottman, Half Moon Bay, CA (US)

(73) Assignee: MANTLE, San Francisco, CA (US)

(21) Appl. No.: 18/799,709

(22) Filed: Aug. 9, 2024

Related U.S. Application Data
(60) Provisional application No. 63/532,205, filed on Aug. 11, 2023.

(51) Int. Cl. B29C 64/393; B33Y 50/02; G06T 19/20

(52) U.S. Cl. CPC B29C 64/393; B33Y 50/02; G06T 19/20; G06T 2219/2016

(57) ABSTRACT

A method for fabricating a physical object is disclosed, including receiving a 3D representation of the physical object, modifying the 3d representation of the physical object, determining a fabrication strategy for forming the physical object, generating fabrication instructions for formation of the physical object based upon the step of determining the fabrication strategy, and fabricating the physical object based upon the step of generating fabrication instructions. The method and system is configured to modify a three-dimensional (3D) representation of a physical object to, in part, compensate for material shrinkage and material removal, improve surface finish, and decrease feature damage during fabrication of the physical object.

### CROSS-REFERENCE TO RELATED APPLICATIONS

This application claims the benefit of U.S. Provisional Application No. 63/532,205 filed on Aug. 11, 2023, the entire disclosure of which is incorporated by reference herein in its entirety.

### TECHNICAL FIELD

The present disclosure relates generally to additive manufacturing.

### BACKGROUND

Additive manufacturing a physical object according to a computer-controlled hybrid process can include: one or more additive steps, e.g., deposition of one or more layers of feedstock by extrusion; one or more transformative steps, e.g., drying the deposited layer of feedstock; and one or more subtractive steps, e.g., machining portions of the printed part. As used herein, the term feedstock means any paste, ink, or other material that is employed or deposited to form a physical object in an additive manufacturing process. In general, additive manufacturing an object can proceed in layers according to a Cartesian coordinate system oriented such that each layer is parallel to an XY plane, with additional layers added to extend or expand the object along a Z-axis that is orthogonal to the XY plane.

Generally, the additive step involves depositing one or more layers of feedstock, where each layer is in the XY plane. Deposition of feedstock at each additive step may be according to a toolpath in which material is extruded to form a layer, e.g., using geometric filling strategies (such as, by way of non-limiting example, rectilinear, serpentine, concentric loops). Toolpaths can be ordered so as to fill a given space with minimal or reduced undesirable overlaps and undesirable voids. Additional layers may be added substantially on top of one another to build the object in a direction along the Z-axis.

The subtractive step removes portions of the previously deposited material to provide for more allowable deviations from the original shape during the additive step and to provide a higher quality surface to the finished part. In general, a single subtractive step may follow deposition of a single additive layer or may follow after deposition of multiple additive layers, or combinations thereof. Some hybrid printing processes apply the subtractive step to remove at least some material from all, or substantially all, surfaces. For example, the subtractive phase may include removing material from some or all horizontal surfaces, vertical surfaces, and/or any nonvertical side surfaces (e.g., nonvertical planar surfaces and curved surfaces) of any regions of one or more printed layers. During the subtractive step, facing techniques may be employed to provide a surface having a known distance from a feedstock deposition apparatus, e.g., a flat horizontal surface, for deposition of subsequent additive layers. Facing can be achieved by employing tools such as an end mill, a face mill, and other facing tool such as a fly cutter, etc. Contouring techniques may be employed to provide the desired or substantially desired dimensions of all non-horizontal surfaces of the dilated part and part features. Contouring can be achieved by employing tools such as a ball end mill, e.g., a hemispherical ball end mill. Undercutting techniques may be employed to form features below an overhanging feature or alternatively stated, to form a recessed surface that is inaccessible using a straight tool. Undercutting can be achieved by employing undercutting tools, e.g., undercut end mills such as ball end mills, keyseat cutters, etc.

After a defined sequence of additive and subtractive steps, the resulting exposed surface of the last additive layer that was deposited may have a predetermined layer height. These features advantageously function to provide a defined and precisely controlled surface for deposition of subsequent additive layers during part formation.

Conventionally, to additively manufacture an object, a computer program, generally known as a “slicer”, accepts as input a 3D virtual representation of the object, e.g., as generated by a Computer Aided Design (CAD) system, as well as 3D printer parameters such as print nozzle width and print speed. The slicer generates computer instructions that the 3D printer processes to print the object. Such instructions may be in the form of a G-Code file, known to those of skill in the art. In a hybrid additive manufacturing process, the G-Code file instructions advantageously describe a toolpath or toolpaths that directs the tools of the 3D printer to perform the additive steps and describe toolpaths that direct the tools of the 3D printer to perform the transformative, as well as the subtractive steps of the hybrid additive manufacturing process.

Further background appears in U.S. Pat. Nos. 10,520,923; 10,807,162; and 11,422,532; which are hereby incorporated by reference herein in their entireties.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for additive manufacturing a physical object comprising: receiving a 3D representation of the physical object; modifying the 3D representation of the physical object; determining a fabrication strategy for forming the physical object comprising: material additive steps; material transformative steps; and material subtractive steps; generating fabrication instructions for formation of the physical object based upon the step of determining the fabrication strategy; and fabricating the physical object based upon the step of generating fabrication instructions.

Wherein said modifying the 3D representation of the physical object comprises dilating or expanding the 3D representation of the physical object to compensate for shrinkage of the physical object during sintering of the physical object in the step of fabricating the physical object.

Wherein the step of dilating or expanding the 3D representation of the physical object to compensate for shrinkage occurs along at least two of an X, Y, and Z-axis of the 3D representation of the physical object. Wherein a magnitude of the step of dilating or expanding along at least two of the X, Y, and Z-axes is uniform relative to each axis. Wherein a magnitude of the step of dilating or expanding along at least two of the X, Y, and Z-axes is nonuniform relative to each axis. Wherein a magnitude of the step of dilating or expanding along at least two of the X, Y, and Z-axes is in the range of eight to ten percent relative to the target final physical object.

Wherein the step of dilating or expanding the 3D representation of the physical object to compensate for shrinkage occurs differentially along one or more of an X, Y, and Z-axis of the 3D representation of the physical object. Wherein the step of dilating or expanding the 3D representation of the physical object to compensate for shrinkage occurs differentially along one or more of an X, Y, and Z-axis of a single feature of the 3D representation of the physical object.

Wherein the step of modifying the 3D representation of the physical object comprises dilating or expanding the 3D representation of the physical object to compensate for material removal during a material subtractive step in the step of fabricating the physical object.

Wherein the step of dilating or expanding the 3D representation of the physical object to compensate for material removal occurs along at least two of an X, Y, and Z-axis of the 3D representation of the physical object. Wherein a magnitude of the step of dilating or expanding along at least two of the X, Y, and Z-axes is uniform relative to each axis. Wherein said dilating or expanding along at least two of the X, Y, and Z-axis is nonuniform relative to each axis. Wherein a magnitude of the step of dilating or expanding along at least two of the X, Y, and Z-axes is in the range of 0.005 to 10 millimeters, 0.05 to 8.0 millimeters, 0.1 to 5.0 millimeters, or 0.3 to 0.5 millimeters.

Wherein the step of modifying the 3D representation of the physical object comprises dilating or expanding nonvertical surfaces of the 3D representation of the physical object to improve a surface finish of the nonvertical surfaces during a material subtractive step in said step of fabricating the physical object.

Wherein the step of dilating or expanding nonvertical surfaces of the 3D representation of the physical object to improve a surface finish of the nonvertical surfaces occurs along only a Z-axis of the 3D representation of the physical object. Wherein a magnitude of the step of dilating or expanding along only the Z-axis is variable between different virtual nonvertical surfaces of the 3D representation of the physical object. Wherein a magnitude of the step of dilating or expanding along the Z-axis is greatest for virtual surfaces of the 3D representation of the physical object that form a ninety-degree angle with the Z-axis of the 3D representation of the physical object and proportionally less for surfaces of the 3D representation of the physical object that form angles of less than ninety degrees with the Z-axis of the 3D representation of the physical object. Wherein a magnitude of the step of dilating or expanding along the Z-axis is in the range of 50 to 500 micrometers or in the range of 0.01 to 1.0 millimeters.

Wherein the step of dilating or expanding nonvertical surfaces of the 3D representation of the physical object to improve a surface finish of the nonvertical surfaces results in the printing of additional layers of material on to the nonvertical surfaces of the physical object during an additive step of said step of fabricating the 3D representation of the physical object. Wherein the step of dilating or expanding nonvertical surfaces of the 3D representation of the physical object to improve a surface finish of the nonvertical surfaces results in preventing or delaying performance of a subtractive step of said step of fabricating the 3D representation of the physical object. Wherein the step of dilating or expanding nonvertical surfaces of the 3D representation of the physical object to improve a surface finish of the nonvertical surfaces results in the removal of a greater depth of material from said nonvertical surfaces relative to a depth of material removed from vertical surfaces of the printed part during a subtractive step of said step of fabricating the 3D representation of the physical object.

Wherein the step of modifying the 3D representation of the physical object comprises dilating or expanding select features of the 3D representation of the physical object that are determined to be susceptible to damage during a material subtractive step in the step of fabricating the physical object.

Wherein the step of dilating or expanding select features of the 3D representation of the physical object occurs along one of an X, Y, and Z-axis of the 3D representation of the physical object. Wherein the step of dilating or expanding select features of the 3D representation of the physical object occurs along two of an X, Y, and Z-axis of the 3D representation of the physical object. Wherein the step of dilating or expanding select features of the 3D representation of the physical object occurs along each of an X, Y, and Z-axis of the 3D representation of the physical object.

Wherein a magnitude of the step of dilating or expanding select features of the 3D representation of the physical object is uniform relative to at least two of the X, Y, and Z-axes. Wherein a magnitude of the step of dilating or expanding select features of the 3D representation of the physical object is nonuniform relative to at least two of the X, Y, and Z-axes.

Wherein the step of dilating or expanding select features of the 3D representation of the physical object comprises merging or dilating more than one of the select features into a single feature within the 3D representation of the physical object.

Wherein the step of dilating or expanding select features of the 3D representation of the physical object results in printing the more than one of the select features as a single feature during an additive step of the step of fabricating the 3D representation of the physical object. Wherein the step of dilating or expanding select features of the 3D representation of the physical object results in forming the more than one of the select features during a subtractive step of the step of fabricating the 3D representation of the physical object from a single feature formed during an additive step of said step of fabricating the 3D representation of the physical object.

Wherein the step of dilating or expanding select features of the 3D representation of the physical object results in preventing or delaying performance of a subtractive step of said step of fabricating the 3D representation of the physical object.

Wherein said modifying the 3D representation of the physical object comprises dilating or expanding less than all of the 3D representation of the physical object along one of an X, Y, and Z-axis of the 3D representation of the physical object. Wherein said modifying the 3D representation of the physical object comprises dilating or expanding less than all of the 3D representation of the physical object along two of an X, Y, and Z-axis of the 3D representation of the physical object. Wherein said modifying the 3D representation of the physical object comprises dilating or expanding less than all of the 3D representation of the physical object along each of an X, Y, and Z-axis of the 3D representation of the physical object.

Wherein said modifying the 3D representation of the physical object comprises dilating a feature of the 3D representation of the physical object along at least two of an X, Y, and Z-axis. Wherein a magnitude of the step of dilating a feature of the 3D representation of the physical object along at least two of an X, Y, and Z-axis is different relative to at least two of the dilated axes.

Wherein said modifying the 3D representation of the physical object comprises dilating the 3D representation of the physical object along at least two of an X, Y, and Z-axis. Wherein a magnitude of the step of dilating the 3D representation of the physical object along at least two of an X, Y, and Z-axis is different relative to at least two of the dilated axes. Wherein a magnitude of dilating different portions or features of the 3D representation of the physical object is different relative to at least two of the dilated axes.

A method for fabricating a physical object comprising; receiving a 3D representation of the physical object; modifying the 3D representation of the physical object; determining a fabrication strategy for forming the physical object; generating fabrication instructions for formation of the physical object based upon the step of determining the fabrication strategy; and fabricating the physical object based upon the step of generating fabrication instructions.

Wherein the step of determining a fabrication strategy for forming the physical object comprises determining material additive toolpaths, material transformative toolpaths, and material subtractive toolpaths. Wherein the step of fabricating the physical object based upon the step of generating fabrication instructions comprises performing material additive steps, material transformative steps, and material subtractive steps.

Wherein the step of modifying the 3D representation of the physical object comprises dilating a feature of the 3D representation of the physical object along at least two of an X, Y, and Z-axis of the 3D representation of the physical object. Wherein a magnitude of the step of dilating a feature of the 3D representation of the physical object along at least two of an X, Y, and Z-axis of the 3D representation of the physical object is the same relative to each dilated axis. Wherein a magnitude of the step of dilating a feature of the 3D representation of the physical object along at least two of an X, Y, and Z-axis of the 3D representation of the physical object is in a range of eight to ten percent, nine to eleven percent, or five to fifteen percent, relative to same axes of the physical object.

Wherein a magnitude of the step of dilating a feature of the 3D representation of the physical object along at least two of an X, Y, and Z-axis of the 3D representation of the physical object is in a range of 0.005 to 10 millimeters, 0.05 to 8.0 millimeters, 0.1 to 5.0 millimeters, or 0.3 to 0.5 millimeters.

Wherein the step of modifying the 3D representation of the physical object comprises dilating different portions of the 3D representation of the physical object different amounts along a same axis of the 3D representation of the physical object. Wherein the step of modifying the 3D representation of the physical object comprises identifying nonvertical surfaces in the 3D representation of the physical object. Wherein the step of modifying the 3D representation of the physical object comprises dilating nonvertical surfaces of the 3D representation of the physical object to improve a surface finish of nonvertical surfaces of the physical object during the step of fabricating the physical object.

Wherein the step of modifying the 3D representation of the physical object comprises dilating the 3D representation of the physical object along a Z-axis of the 3D representation of the physical object. Wherein a magnitude of the step of dilating the 3D representation of the physical object along a Z-axis of the 3D representation of the physical object is different for different nonvertical surfaces of the 3D representation of the physical object. Wherein a magnitude of the step of dilating the 3D representation of the physical object along a Z-axis of the 3D representation of the physical object is greater for surfaces of the 3D representation of the physical object that form a ninety-degree angle with the Z-axis of the 3D representation of the physical object than for surfaces of the 3D representation of the physical object that form less than ninety-degree angles with the Z-axis of the 3D representation of the physical object. Wherein a magnitude of the step of dilating the 3D representation of the physical object along a Z-axis of the 3D representation of the physical object is in a range of 50 to 500 micrometers or in the range of 0.01 to 1.0 millimeters. Wherein the step of modifying the 3D representation of the physical object results in removal of a greater depth of material from nonvertical surfaces than from vertical surfaces during the step of fabricating the physical object.

Wherein the step of modifying the 3D representation of the physical object comprises the step of identifying features of the 3D representation of the physical object that are susceptible to damage during the step of fabricating the physical object. Wherein the step of modifying the 3D representation of the physical object comprises dilating a feature of the 3D representation of the physical object that is susceptible to damage during the step of fabricating the physical object. Wherein the step of modifying the 3D representation of the physical object comprises dilating a first feature and a second feature adjacent to the first feature of the 3D representation of the physical object to form a single feature in the 3D representation of the physical object. Wherein the step of dilating a first feature and a second feature adjacent to the first feature of the 3D representation of the physical object to form a single feature in the 3D representation of the physical object results in the formation of the single feature during a material additive step of the step of fabricating the physical object. Wherein dilating a first feature and a second feature adjacent to the first feature of the 3D representation of the physical object to form a single feature in the 3D representation of the physical object results in formation of the first feature and the second feature of the 3D representation of the physical object during a material subtractive step of the step of fabricating the physical object.

Wherein the step of modifying the 3D representation of the physical object results in performing fewer material subtractive steps while forming a first portion of the physical object than to when forming a second portion of the physical object during the step of fabricating the physical object. Wherein the step of modifying the 3D representation of the physical object comprises dilating different portions of the 3D representation of the physical object by different amounts along a same axis of the 3D representation of the physical object.

A system for additive manufacturing of a physical object that performs the above recited steps.

A system for additive manufacturing of a physical object comprising an electronic processor and a persistent memory comprising instructions that, when executed by the electronic processor, configure the electronic processor to perform the above recited steps.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a diagram of a method according to the present disclosure.

FIG. 2 is a diagram of subroutines or methods according to the present disclosure.

FIG. 3 is a diagram of a method according to the present disclosure.

FIG. 4 is a representation of an elevation view of a part according to the present disclosure.

FIG. 5 is a diagram of a method according to the present disclosure.

FIG. 6 is a representation of a part according to the present disclosure.

FIG. 7 is a representation of a part according to the present disclosure.

FIG. 8 is a representation of a part according to the present disclosure.

FIG. 9 is a diagram of a method according to the present disclosure.

FIG. 10 is a representation of a part according to the present disclosure.

FIG. 11 is a representation of a part according to the present disclosure.

FIG. 12 is a representation of a part according to the present disclosure.

FIG. 13 is a representation of a part according to the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts. While different examples are described, features of each example can be used interchangeably with other described examples. In other words, any of the features of each of the examples can be mixed and matched with each other, and examples should not necessarily be rigidly interpreted to only include the features shown or described.

### Overview

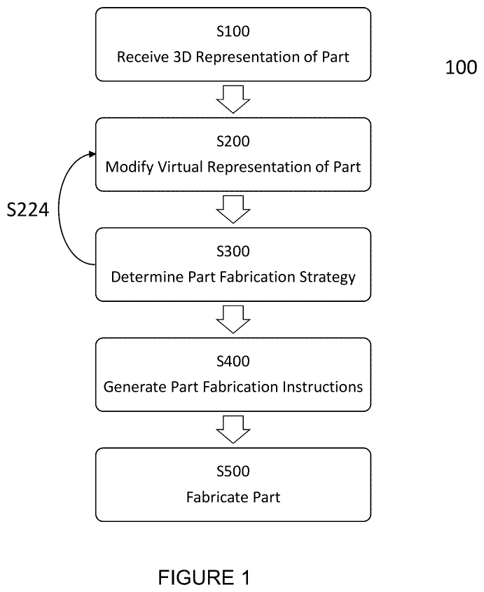

FIG. 1 illustrates an additive manufacturing method 100 for printing a 3D object or part according to the present disclosure. Exemplary method 100 employs, in part, steps: S100, receiving a 3D representation or virtual representation of a part or object to be printed; S200, modifying the virtual representation of the part; S300, determining a printing strategy for the part; S400, generating printing instructions for fabrication or printing of the part; and S500, fabricating or printing the part or object. The steps of method 100 may be executed in the order illustrated in FIG. 1, in an alternative order to that illustrated in FIG. 1, in an iterative closed loop or process feedback driven order, or in a parallel nonsequential manner.

Method 100 may be at least partially computer implemented and may include additive manufacturing of an object or part. Method 100 is implemented, in part, by employing computer software that is integrated as part of a slicer program. Alternately, or in addition, the method 100 is used together with a slicer, e.g., as a plug-in or standalone module that communicates with a slicer. Alternatively, or in addition to, the method 100 is implemented by employing a dedicated computer software in which a slicer program is embedded.

Method 100 may be implemented with a hybrid printing system employing a hybrid printing process, which may include, but is not limited to, an additive step, a transformative step, and a subtractive step. The hybrid printing system of the present disclosure may include a system configured to perform additive, transformative, and subtractive fabrication tasks such as the systems described in U.S. Pat. No. 10,807,164, entitled System and Method for Additive Metal Manufacturing, filed Aug. 13, 2018, and U.S. Publication No. 2022/0097190, entitled Waste Collection and Abatement During Hybrid Additive and Subtractive Manufacturing, filed Sep. 29, 2021, which are hereby incorporated herein in their entireties by reference. The hybrid printing system preferably includes one or more: deposition mechanisms (e.g., including a print material dispenser, such as a needle or other nozzle), material removal mechanisms, and movement mechanisms, and can additionally or alternatively include any other suitable elements.

The hybrid printing system (e.g., the deposition mechanism) is preferably operable to fabricate parts by depositing precursor material such as a feedstock, e.g., as described in U.S. Pat. No. 10,087,332, entitled Sinterable Metal Paste for Use In Additive Manufacturing, filed May 12, 2017, and U.S. Publication No. 2023/0057940, entitled Metal Paste for Additive Manufacturing and Method of 3D Printing, filed Jul. 27, 2022, which are hereby incorporated herein in their entireties by reference. However, the deposition mechanism and/or other elements of the fabrication system can additionally or alternatively be operable to fabricate parts of any other suitable composition.

The material removal mechanism preferably includes one or more milling tools and is preferably configured to automatically change between different milling tools (e.g., using an automatic tool changer). The milling tools can include, for example, end mills (e.g., square, radiused, ball, spherical, keyseat cutters, chamfering, etc.), fly cutters, facing tools, and/or any other suitable milling tools.

The movement mechanisms (e.g., translation mechanisms such as linear actuators, rotation mechanisms such as rotary actuators, etc.) are preferably mechanisms configured to reposition the manufactured part (e.g., during fabrication) relative to the deposition and/or material removal mechanisms (e.g., by moving the part, such as by moving a stage on which the part is supported and/or to which the part is affixed; by moving the deposition and/or material removal mechanisms relative to the manufactured part; etc.). The motion of the movement mechanisms is preferably controlled electronically (e.g., computer numerical control (CNC) movement mechanisms) but can additionally or alternatively be controlled in any other suitable manner.

The system may include one or more computing systems (e.g., configured to communicate with and/or control operation of the fabrication systems, etc.). The computing systems can include computing devices integrated with (e.g., embedded in, directly connected to, etc.) the fabrication system(s), user devices (e.g., smart phone, tablet, laptop and/or desktop computer, etc.), remote servers (e.g., internet-connected servers, such as those hosted by a toolpath generation service provider and/or fabrication system manufacturer), and/or any other suitable computing systems. The system can, however, additionally or alternatively include any other suitable elements in any suitable arrangement.

### Step S100:

In step S100 of method 100, a 3D representation of a part or object to be printed, also referred to as a “virtual part”, is received. Step S100 functions to determine or capture the parameters of the part to be printed or fabricated (e.g., the parameters from which fabrication toolpaths should be generated). The virtual part may be a computer representation of a physical object, such as a computer-aided design, CAD, file. The virtual part may be received by a computing system incorporated into or otherwise associated with the hybrid printing system. The virtual part can be received from another computing system, from a virtual parts database, from a user (e.g., using a CAD application running on the computing system), from a set of one or more sensors (e.g., 3D scanning system), and/or from any other suitable entities. The 3D representation may be in the form of layers or slices of the object or part to be printed. The 3D representation may further be in the form of an entire object or a portion of the object.

### Step S200:

In step S200 of method 100, the 3D representation of a part or object to be printed is modified or adapted for use in the part fabrication process. Step S200 is preferably performed by the computing system (and/or another computing system) and is preferably performed in response to receiving the 3D representation of step S100 but can additionally or alternatively be performed by any suitable entity or entities with any suitable timing.

Step S200 may include determining a part orientation. The orientation can be an orientation associated with the original part or can be determined based on fabrication criteria. In a first example, a broad face of the part is selected as a bottom face (e.g., wherein a vertical or Z-axis orientation is defined as normal to the bottom face and/or a vertical position is defined as zero at the bottom face), which can facilitate fixturing and/or adhesion to a fabrication system stage. In a second example, a concave surface is selected as an upward-facing surface (e.g., wherein no other portion of the part is above the concave surface), which can reduce overhanging features, thereby facilitating subtractive fabrication processes. However, the orientation can be selected in any suitable manner.

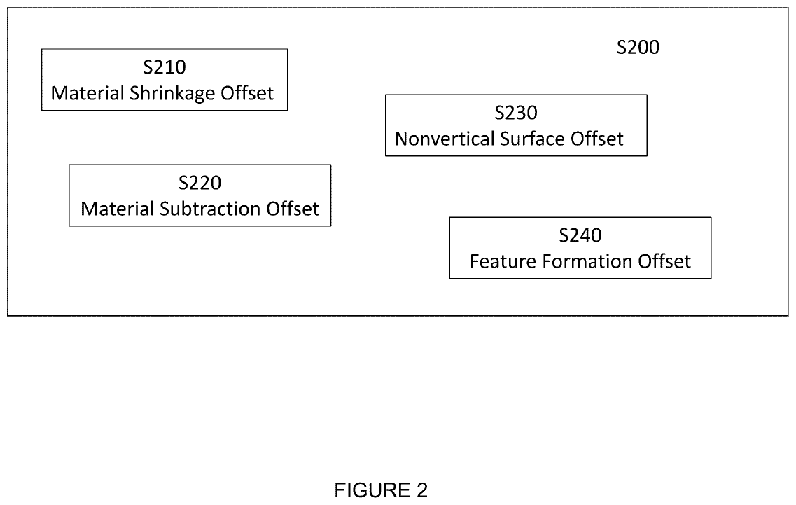

As shown in FIG. 2 and described in greater detail herein, Step S200 may further include various modifications of the 3D representation of the part including, but not limited to: a material shrinkage offset (S210); a material subtraction offset (S220); a nonvertical surface offset (S230); a feature formation offset (S240); and combinations thereof each described in greater detail herein.

### Step S300:

Step S300 of method 100 functions to determine or generate a part fabrication strategy or strategies. For example, step S300 generates efficient toolpaths for the hybrid printing system including: determining additive toolpaths; determining and interspersing transformative toolpaths; determining and interspersing subtractive toolpaths; determining setup toolpaths; determining and interspersing auxiliary toolpaths; and/or determining any other suitable elements necessary for fabrication of the part. S300 can be performed after (e.g., in response to) step S200, can be performed as an iterative process with step S200 via step S224, and/or can additionally or alternatively be performed at any other suitable time.

According to examples in which method 100 is integrated with a slicer, the additive manufacturing strategies may be generated by the slicer and provided to method 100. According to examples in which method 100 is used together with a separate slicer, the additive manufacturing strategies may be communicated by the slicer to method 100.

According to some examples, the additive manufacturing strategies may be in the form of specific toolpaths. The additive manufacturing strategies may be in the form of a series of instruction schema. According to some examples, the additive manufacturing strategies may specify one or more material road widths, one or more rectilinear roads, one or more perimeter roads, one or more concentric roads, and/or one or more preset custom toolpaths. Some or all the additive manufacturing strategies may include corrective strategies, such as one or more chopped loops and/or one or more stretched or elongated corners. Additional details related to toolpath strategies and toolpath generation can be found in U.S. patent application Ser. No. 17/883,236, entitled Undesirable Void Identification and Correction in 3D Printing, filed Aug. 8, 2022, herein incorporated in its entirety by reference.

### Step S400:

Step S400 of method 100 functions to determine part fabrication instructions. For example, step S400 generates instructions that can be executed by the hybrid printing system (e.g., resulting in fabrication of the target part or physical object). Step S400 can be part of and/or performed concurrently with step S300 (e.g., wherein the toolpaths are directly generated as G-Code representations and/or other machine instructions), performed after (e.g., in response to) performance of step S300 (e.g., generating machine instructions, such as G-Code, based on the toolpaths determined in step S300), and/or performed with any other suitable timing. However, the machine instructions can additionally or alternatively be generated in any other suitable manner.

### Step S500:

Step S500 of method 100 functions to fabricate the desired part. For example, step S500 includes controlling the fabrication or hybrid printing system based on the instructions of step S400. Step S500 is performed following S400 (e.g., in response to S400; after S400 and in response to a trigger, such as a part fabrication request; etc.) but can additionally or alternatively be performed with any other suitable timing. S500 can include fabricating one or more copies of the target part using one or more fabrication systems.

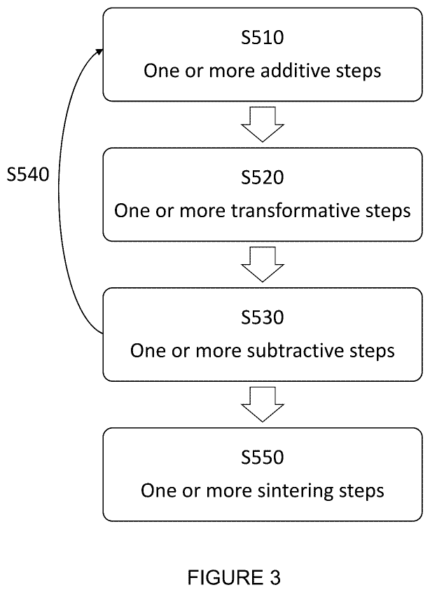

As shown in FIG. 3, step S500 functions to execute one or more additive steps S510, e.g., deposition of one or more layers of feedstock by extrusion; one or more transformative steps S520, e.g., drying the deposited layer(s) of feedstock to form a green body part; one or more subtractive steps S530, e.g., machining portions of the printed green body part; and a sintering step S550 in which the green body part is sintered to form a finished or target part. As an iterative process, it will be understood that steps S510 through S530 can be repeated any number of times through step S540, prior to proceeding to step S550 and the sintering of the green body part.

### Modification of 3D Part Representation (Step S200):

As shown in FIG. 2, step S200 includes, but is not limited to, various subroutines or methods of modifying the 3D representation of the part including, but not limited to: S210, material shrinkage offset; S220, material subtraction offset; S230, nonvertical surface offset; S240, feature formation offset; and combinations thereof. While these various subroutines or methods are herein described independently or separately from one another, the steps performing the described functions or methods may be performed in any sequence or may be combined or aggregated with one another to produce the desired fabrication strategy and, hence, the desired finished or target part or physical object.

In one example, subroutine or method S210 is performed initially and all other subroutines and methods S220, S230, and S240 are performed to the modified 3D representation obtained from subroutine or method S210. This is due, in part, to the fact that the modifications of the subroutines and methods S220, S230, and S240 and the subsequent associated subtraction of such material is intended to arrive at the target green body part corresponding to the modified 3D part representation obtained in S210. In another example, with respect to the order of performing S220, S230, and S240 after S210, S220 is performed first; S240 is performed on or to the modified 3D part representation of S220; and S230 is performed on or to the modified 3D part representation of S240.

In certain examples of the present disclosure, the original 3D representation of the part is in the form of a solid body, e.g., a STEP file. In such examples, a dilation can be achieved by volumetrically expanding and distorting the solid body such that there is a given offset from every original surface. Alternatively, an original solid body 3D representation of the part can be converted into a mesh. The mesh may be, for example, a triangulated mesh or STL file, or a mesh of any other geometric basis. In such examples, the dilation is achieved through the identification of an angle of each geometric shape, forming an offset mesh with a shift or growth directed orthogonally off the face of each geometric form.

In an alternative example, the desired or target physical object is defined by NURBS (Non-Uniform Rationale B-Spline) modeling and the dilation or modification of the 3D representation is applied to the algorithmic surface of the definition.

In an alternative example, the dilation or modification of the 3D representation is applied on a slice or layer basis rather than on a whole part basis.

It will be understood that the degree or amount of modification desired under step S200 for any given part or part feature may vary depending upon the material employed to fabricate such part. For example, it is well understood that different materials have different material properties such as: rates of shrinkage during drying and sintering, brittleness, elasticity, fatigue limits, shear strength, ductility, and malleability, etc. Such material property differences may necessitate that the below modifications be tailored to each material employed for fabrication of a part according to the present disclosure.

### S210—Material Shrinkage Offset:

In certain examples, step S200 includes subroutine or method S210 that functions to expand or dilate the 3D representation of the part to compensate for part shrinkage and/or deformation resulting from the drying of the printed part or partially printed part during green body formation and to compensate for green body part shrinkage resulting from the sintering of the green body part. To compensate for such material shrinkage, the original 3D representation of the part is scaled up, expanded, or dilated, relative to the target final part or physical object, to generate the desired dimensioned finished or target part subsequent to any shrinkage. The part dilation of subroutine or method S210 may have a magnitude of, but is not limited to, eight to ten percent, nine to eleven percent, or five to fifteen percent, relative to the target final part or physical object. The part dilation of subroutine or method S210 may have an absolute magnitude of 0.5 to 1.5 centimeters for a physical object having a largest dimension of approximately 10 centimeters; 1.0 to 3.0 centimeters for a physical object having a largest dimension of approximately 20 centimeters; 1.5 to 4.5 centimeters for a physical object having a largest dimension of approximately 30 centimeters; and 2.5 to 7.5 centimeters for a physical object having a largest dimension of approximately 50 centimeters.

In certain examples, the part dilation of subroutine or method S210 is uniform in magnitude in all of the X, Y, and Z-axes of the part. In certain examples, the part dilation of subroutine or method S210 is not uniform in magnitude in all of the X, Y, and Z-axes of the part. For example, part dilation may be greater along the Z-axis than the X and Y-axes.

In certain examples, the part dilation of subroutine or method S210 is not uniform across a part in a single axis of the part. For example, the 3D representation of a part may incorporate a feature such as a pillar having a base that has a larger width than a width of the top of the pillar. Hence, such part feature may experience differential shrinkage along the X-axis and/or Y-axis at the base of the pillar relative to the apex or top of the pillar. This differential shrinkage can also be compensated for in subroutine or method S210 on a whole part level, e.g., for an entire 3D part having, for example, a tapered pillar form.

### S220—Material Subtraction Offset:

In certain examples, step S200 further includes subroutine or method S220 that functions to expand or dilate the 3D representation of the part to compensate for the removal of printed part material during the subtractive step, S530, of the hybrid printing process (FIG. 3). As previously described, after a specified number of part material layers have been printed and transformed, for example dried, to form a green body part or portion of a green body part, a subtractive step is employed to machine all or a portion of the surfaces of the green body part. The machining or surfacing of the part performed during the subtractive step provides the green body part or portion of a part with a desired surface structure and finish.

Subroutine or method S220 preferably includes expanding or dilating the 3D representation of the part to generate a dilated part, preferably based on the target part. The dilated virtual part or 3D representation can function as a target for additive fabrication (e.g., target for fabrication in the absence of any subtractive steps). The magnitude or amount of the expansion or dilation performed in subroutine or method S220 is dependent upon the part feature being formed, e.g., a sharp corner, pillar, etc., and is in the range of 0.005 to 10 millimeters, from 0.05 to 8.0 millimeters, 0.1 to 5.0 millimeters, or 0.3 to 0.5 millimeters. Hence, those skilled in the art will recognize that magnitude of the expansion or dilation performed in subroutine or method S220 may vary from feature to feature within a single 3D representation of a part. Such expansion can allow for consistent material removal during the subtractive fabrication step S530. Such consistent material removal advantageously provides for, in part: the formation of part features that are not otherwise amiable to formation by material printing alone, e.g., sharp corners, edges, thin fins, pillars, etc.; the reduction and/or elimination of exterior material voids in the part; the improved overall vertical surface finish of the finished part, e.g., increasing the surface resolution of features from a material deposition nozzle size of, for example, approximately 0.8 millimeters to that capable by a relatively small milling tool, for example, approximately less than 0.1 millimeters.

### S230—Nonvertical Surface Offset:

Step S200 of method 100 further includes subroutine or method S230 that functions to expand or dilate the 3D representation of the part along a single axis, for example the vertical or Z-axis of the part. Generally speaking, in the method of the present disclosure, it is desirable to fabricate a part with the highest quality surface finish without resorting to post-fabrication, i.e., post part sintering, surfacing techniques and steps. This advantageously provides the desired part in a more cost, time, and material efficient manner. Furthermore, it is often the case that the part surfaces requiring the highest quality surface finishes are the nonvertical surfaces of the part.

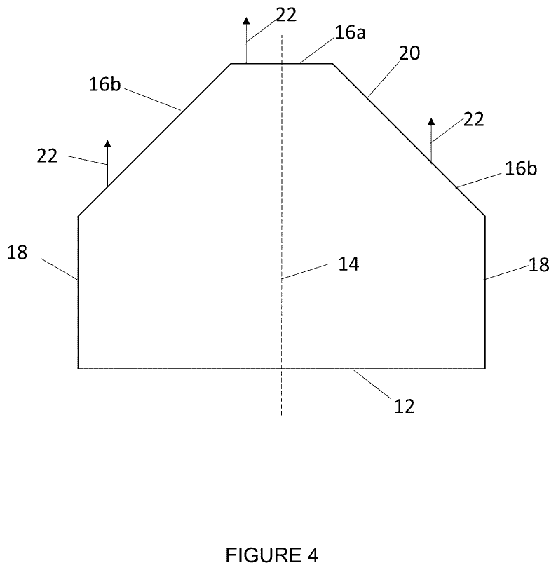

With reference to FIG. 4, in the context of the present disclosure, the term “nonvertical” means any surface of a part or part representation 20 (1) that does not form the bottom face or surface 12 and (2) that forms an angle greater than zero degrees with the vertical or Z-axis 14 of the part 20. For example, nonvertical may mean a surface that forms a positive angle, i.e., not an overhanging angle, greater than zero degrees with the vertical or Z-axis of the part 20. Accordingly, surfaces 16a and 16b are considered nonvertical surfaces, and surfaces 18 are considered vertical surfaces.

According to certain examples of the present disclosure, in order to achieve the highest quality surface finish for nonvertical part surfaces, it is preferable to dilate or expand the 3D representation of the part such that the nonvertical surfaces 16a and 16b of the part 20 are extended or offset in a direction 22 that is parallel to the vertical or Z-axis 14 of the part 20. The nonvertical surface offset of subroutine or method S230 may be in the magnitude of, but is not limited to, 50-500 micrometers, 75-500 micrometers, or 0.05 to 1.0 millimeters.

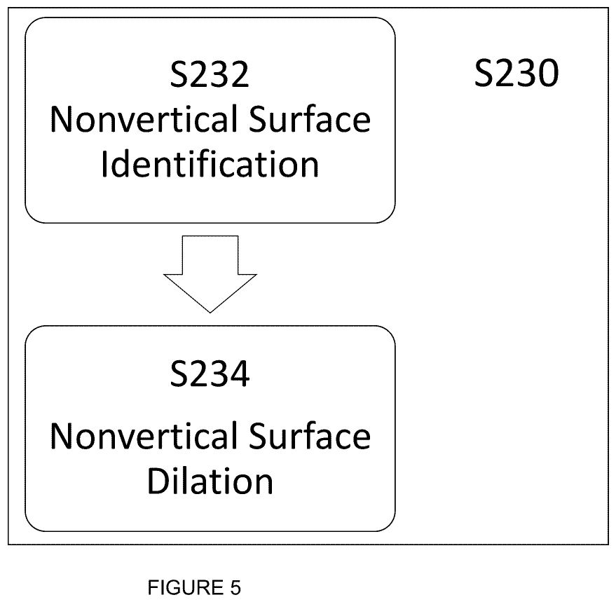

As shown in FIG. 5, subroutine or method S230 includes, but is not limited to, step S232, nonvertical surface identification and step S234 nonvertical surface dilation. Step S232, nonvertical surface identification, can be performed manually, automatically, or through a hybrid process. Preferably step S232 is performed through an automated process during which the nonvertical surfaces are automatically identified relative to the predetermined part axis, for example the above described determined vertical or Z-axis that is normal to the bottom face 12 of the part 20. In certain examples, the nonvertical surfaces and each of these surfaces' relative angle(s) are identified via a slice-by-slice analysis of the part. Such part slices being generated by a slicer program associated with method 100.

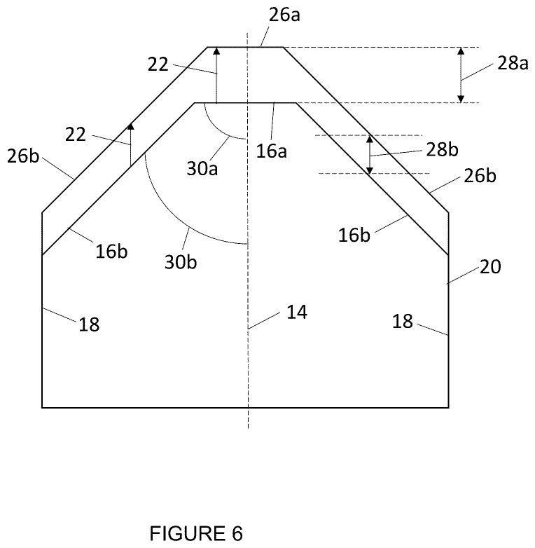

Once the nonvertical surfaces of the part are identified in step S232, the identified nonvertical surfaces of the 3D representation of the part are dilated in step S234. With reference to FIG. 6, dilation of the nonvertical surfaces 16a and 16b functions to expand or extend the nonvertical surfaces 16a and 16b of the 3D representation of the part in a direction 22 that is parallel to the vertical axis 14 of the part 20. Surface 26a represents the modified or dilated surface 16a, and surfaces 26b represent the modified or dilated surfaces 16b of part 20. Length 28a represents the length, magnitude, or amount of dilation applied to surface 16a, and length 28b represents the length, magnitude, or amount of dilation applied to surfaces 16b.

As shown in FIG. 6, length 28a is greater than length 28b. According to certain examples of the present disclosure, application of subroutine or method S230 results in dilation of the nonvertical surfaces of the part to varying extents based upon the angle of the surface relative to the vertical or Z-axis of the part. The greatest amount or magnitude of dilation occurring on surfaces oriented orthogonal or at a ninety-degree angle to the vertical axis 14 and progressively less dilation occurring on surfaces oriented at angles less than orthogonal or at an angle of less than ninety degrees to the vertical axis 14. Vertical surfaces 18 form a zero-degree angle with the vertical axis 14 (i.e., surfaces 18 are parallel to vertical axis 14) and are not dilated according to subroutine or method S230. For example, if angle 30a of surface 16a forms a ninety-degree angle with the vertical axis 14 and angle 30b of surface 16b forms a forty-five-degree angle with vertical axis 14, length 28a will be greater than length 28b. As shown in FIG. 6, subroutine or method S230 functions to expand only nonvertical surfaces 16a and 16b in a direction parallel to the vertical axis 14. Vertical surfaces 18 are unchanged and not dilated in any direction or along any axis as a function of subroutine or method S230.

In certain examples, subroutine or method S230 is applied to less than all the features or relevant surfaces of a part. For example, the two surfaces 26b may be modified or dilated in direction 22 in a nonuniform or unequal manner.

Considered in view of the function of step S500 of method 100, subroutine or method S230 of step S200 results in the printing of additional layers of material on to the nonvertical surfaces of the part. Alternatively stated, subroutine or method S230 may result in preventing or delaying method 100 from performing the subtractive step S530 so as to build relatively more material on the nonvertical surfaces of a part prior to machining or finishing of such surfaces in the subtractive step S530. While these additional printed layers ultimately necessitate the removal of a greater amount of material during the subtractive step, the additional material also advantageously allows for a higher quality surface finish to be achieved during the subtractive step on the nonvertical surfaces for which a high-quality finish is often most desired.

### S240—Feature Formation Offset:

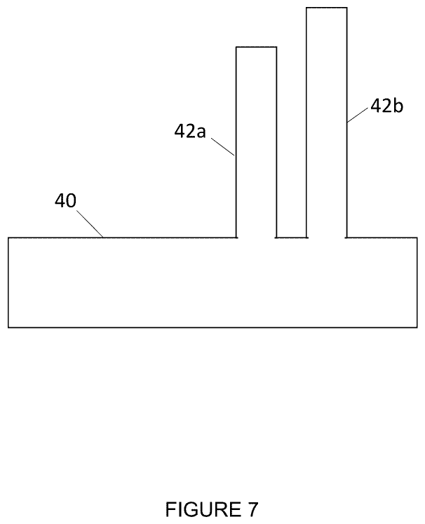

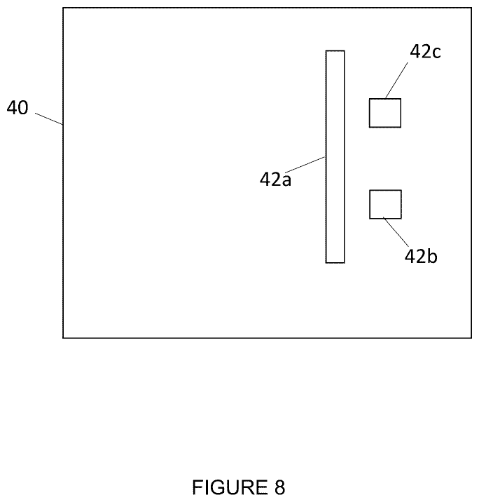

With reference to FIGS. 7 through 13, subroutine or method S240 functions to facilitate the formation of specific features or structures of a part that may be considered susceptible to deformation, damage, or breakage during fabrication. For example, by way of nonlimiting example, a part feature having a dimension of approximately less than 1.0 millimeters, less than 2.5 millimeters, or less than 5 millimeters, may be considered a feature susceptible to damage during fabrication, according to the present disclosure. As shown in the elevation view of FIG. 7 and the plan view of FIG. 8, relatively tall and/or thin features or structures 42a, 42b, and 42c, such as fins and towers, employed on a part 40 can be more susceptible to breakage during the subtractive step S530 (FIG. 3), i.e., while the surfaces of such feature 42 are being machined, as compared to relatively shorter and/or wider features or structures on the same part.

According to the present disclosure, to overcome or mitigate the risk of feature failure or breakage, subroutine or method S240 advantageously functions to dilate or expand the feature of interest in the 3D representation of the part. Thereby resulting in an initially enlarged more robust and stable form of the feature that is printed in additive step S510 (FIG. 3). Hence, during the subsequent subtractive step S530, in which the feature's surfaces are machined to the target dimensions, more material is generally present around the feature to enhance the stability and robustness of the feature during the subtractive step S530.

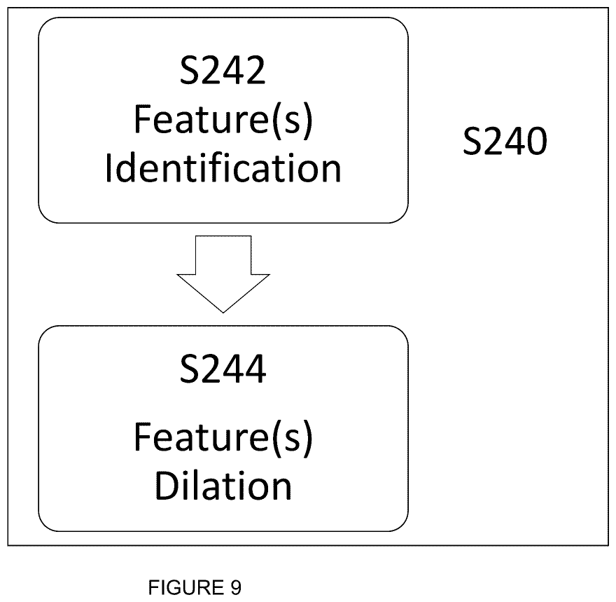

As shown in FIG. 9, subroutine or method S240 includes, but is not limited to, step S242, feature identification and step S244 feature dilation. Step S242 feature identification can be performed manually, automatically, or through a hybrid process. Preferably, step S242 is performed through an automated process during which the feature or features are automatically identified relative to the predetermined part axis, for example the above described determined vertical or Z-axis that is normal to the bottom face of the part. In certain examples, the features are identified via a slice-by-slice analysis of the part. Such part slices being generated by a slicer program associated with method 100.

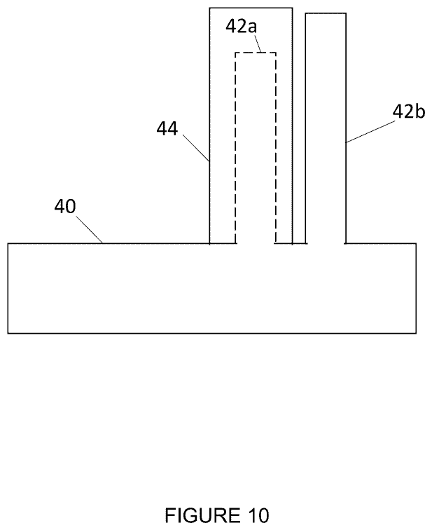

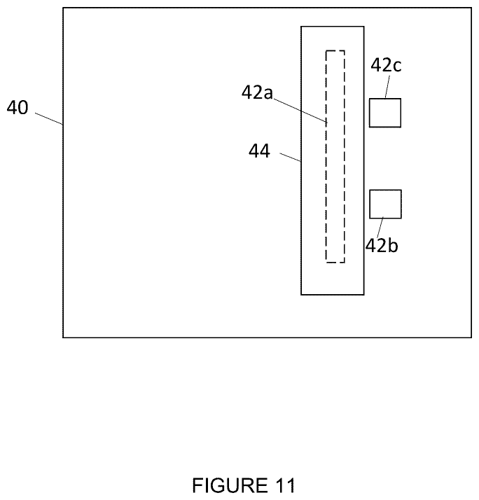

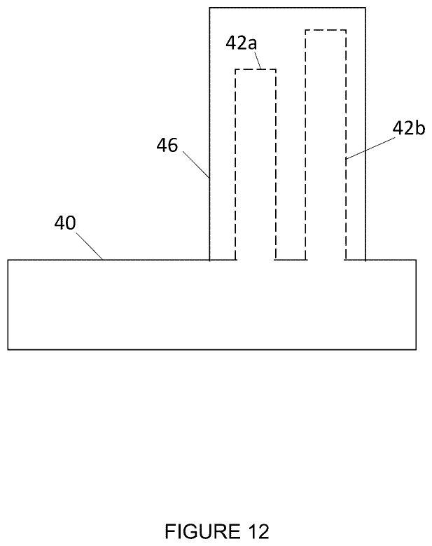

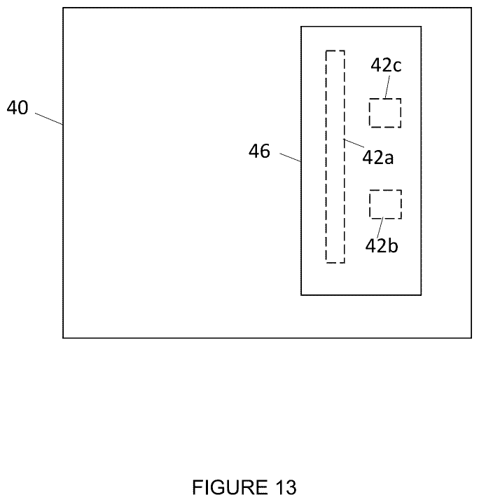

Once the susceptible features 42a, 42b, and 42c of part 40 are identified through step S242, the identified features 42a, 42b, and 42c of the 3D representation of the part are dilated in step S244. With reference to FIGS. 10 through 13, according to the present disclosure, depending on the position of the identified susceptible features within the part, dilation step S244 may function to dilate a single susceptible feature 42a into a single dilated feature 44 (FIGS. 10 and 11) or may function to group adjacent susceptible features 42a, 42b, and 42c and dilate such group into a single dilated feature 46 (FIGS. 12 and 13).

Considered in view of the function of step S500 of method 100, subroutine or method S240 of step S200 results in the printing of additional material on one or all of the exposed surfaces of the identified susceptible feature of the part. In certain examples, subroutine or method S240, in turn, interacts with step S300 such that step S300 provides instructions to step S500 to prevent or delay method 100 from performing the subtractive step S530 on dilated features 44 and 46 such that dilated features 44 and 46 are subjected to fewer subtractive steps S530 relative to the other portions of the part that were not identified as susceptible features in step S242. In certain examples, subroutine or method S240 interacts with step S300 such that step S300 provides instructions to step S500 to only perform one subtractive step S530 after complete formation of the dilated features 44 and 46. These examples are advantageous as it minimizes the number of times machining stresses are applied to the dilated features 44 and 46 and, hence, to features 42a, 42b, and 42c, thereby reducing the risk of breakage or failure of such features. This example is further advantageous as it results in the printed, dilated susceptible feature being milled or surfaced in a top-down manner in which the largest width or diameter of the feature remains at the base of the feature until the end of the feature formation. Alternatively stated, the inventive process avoids situations in which the largest width or diameter of the features are milled or surfaced while being supported from underneath by narrower, less robust portion of the feature. It will be understood that in such example, the height of the susceptible feature may be limited by the length of the milling tool.

Those skilled in the art will recognize that the identification of susceptible features of the step or subroutine S242 and the magnitude of the dilation of the susceptible feature of the step or subroutine S244 is dependent upon the exact composition of the material being printed and the nozzle size of the printer employed, which in turn defines the width of the printed material road. By way of non-limiting example, step or subroutine S242 may employ material composition dependent criteria such as the actual dimensions of a feature, e.g., features having a smallest dimension of approximately 5 millimeters or less and/or an aspect ratio, Z/X and/or Z/Y, greater than 5. Similarly, and by way of non-limiting example, step or subroutine S244 may employ composition dependent dilation of the susceptible feature, e.g., on a magnitude of 5 to 10 millimeters in one, two or each of the X, Y, and Z axis.

Although the disclosure and examples thereof have been described in terms of particular examples and applications, one of ordinary skill in the art, in light of this teaching, can generate additional examples and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for fabricating a physical object comprising:
receiving a 3D representation of the physical object;
modifying the 3D representation of the physical object;
determining a fabrication strategy for forming the physical object;
generating fabrication instructions for formation of the physical object based upon the step of determining the fabrication strategy; and
fabricating the physical object based upon the step of generating fabrication instructions.

2. The method of claim 1 wherein the step of determining a fabrication strategy for forming the physical object comprises determining material additive toolpaths, material transformative toolpaths, and material subtractive toolpaths.

3. The method of claim 1 wherein the step of fabricating the physical object based upon the step of generating fabrication instructions comprises performing material additive steps, material transformative steps, and material subtractive steps.

4. The method of claim 1 wherein the step of modifying the 3D representation of the physical object comprises dilating a feature of the 3D representation of the physical object along at least two of an X, Y, and Z-axis of the 3D representation of the physical object.

5. The method of claim 4 wherein a magnitude of the step of dilating a feature of the 3D representation of the physical object along at least two of an X, Y, and Z-axis of the 3D representation of the physical object is the same relative to each dilated axis.

6. The method of claim 4 wherein a magnitude of the step of dilating a feature of the 3D representation of the physical object along at least two of an X, Y, and Z-axis of the 3D representation of the physical object is in a range of eight to ten percent, nine to eleven percent, or five to fifteen percent relative to same axes of the physical object.

7. The method of claim 4 wherein a magnitude of the step of dilating a feature of the 3D representation of the physical object along at least two of an X, Y, and Z-axis of the 3D representation of the physical object is in a range of 0.005 to 10 millimeters, 0.05 to 8.0 millimeters, 0.1 to 5.0 millimeters, or 0.3 to 0.5 millimeters.

8. The method of claim 1 wherein the step of modifying the 3D representation of the physical object comprises dilating different portions of the 3D representation of the physical object in different amounts along a same axis of the 3D representation of the physical object.

9. The method of claim 1 wherein the step of modifying the 3D representation of the physical object comprises identifying nonvertical surfaces in the 3D representation of the physical object.

10. The method of claim 1 wherein the step of modifying the 3D representation of the physical object comprises dilating nonvertical surfaces of the 3D representation of the physical object to improve a surface finish of nonvertical surfaces of the physical object during the step of fabricating the physical object.

11. The method of claim 1 wherein the step of modifying the 3D representation of the physical object comprises dilating the 3D representation of the physical object along a Z-axis of the 3D representation of the physical object.

12. The method of claim 11 wherein a magnitude of the step of dilating the 3D representation of the physical object along a Z-axis of the 3D representation of the physical object is different for different nonvertical surfaces of the 3D representation of the physical object.

13. The method of claim 11 wherein a magnitude of the step of dilating the 3D representation of the physical object along a Z-axis of the 3D representation of the physical object is greater for surfaces of the 3D representation of the physical object that form a ninety-degree angle with the Z-axis of the 3D representation of the physical object than for surfaces of the 3D representation of the physical object that form less than ninety-degree angles with the Z-axis of the 3D representation of the physical object.

14. The method of claim 11 wherein a magnitude of the step of dilating the 3D representation of the physical object along a Z-axis of the 3D representation of the physical object is in a range of 50 to 500 micrometers or in the range of 0.01 to 1.0 millimeters.

15. The method of claim 1 wherein the step of modifying the 3D representation of the physical object results in removal of a greater depth of material from nonvertical surfaces than from vertical surfaces during the step of fabricating the physical object.

16. The method of claim 1 wherein the step of modifying the 3D representation of the physical object comprises the step of identifying features of the 3D representation of the physical object that are susceptible to damage during the step of fabricating the physical object.

17. The method of claim 1 wherein the step of modifying the 3D representation of the physical object comprises dilating a feature of the 3D representation of the physical object that is susceptible to damage during the step of fabricating the physical object.

18. The method of claim 1 wherein the step of modifying the 3D representation of the physical object comprises dilating a first feature and a second feature adjacent to the first feature of the 3D representation of the physical object to form a single feature in the 3D representation of the physical object.

19. The method of claim 18 wherein the step of dilating a first feature and a second feature adjacent to the first feature of the 3D representation of the physical object to form a single feature in the 3D representation of the physical object results in the formation of the single feature during a material additive step of the step of fabricating the physical object.

20. The method of claim 18 wherein dilating a first feature and a second feature adjacent to the first feature of the 3D representation of the physical object to form a single feature in the 3D representation of the physical object results in formation of the first feature and the second feature of the 3D representation of the physical object during a material subtractive step of the step of fabricating the physical object.

21. The method of claim 1 wherein the step of modifying the 3D representation of the physical object results in performing fewer material subtractive steps while forming a first portion of the physical object than to when forming a second portion of the physical object during the step of fabricating the physical object.

22. The method of claim 1 wherein the step of modifying the 3D representation of the physical object comprises dilating different portions of the 3D representation of the physical object by different amounts along a same axis of the 3D representation of the physical object.
